(19) United States
(12) Patent Application Publication
(10) Pub. No.: US 2009/0035509 A1
(43) Pub. Date: Feb. 5, 2009

(54) Touch Fasteners With Embedded Fibers

(75) Inventor: Wallace L. Kurtz, JR., Lunenburg, MA (US)

Correspondence Address: FISH & RICHARDSON PC, P.O. BOX 1022, MINNEAPOLIS, MN, 55440-1022, US

(73) Assignee: VELCRO INDUSTRIES B.V., Curacao (AN)

(21) Appl. No.: 11/832,004

(22) Filed: Aug. 1, 2007

(51) Int. Cl. B32B 3/06; B28B 5/00

(52) U.S. Cl. 428/100; 264/241

(57) ABSTRACT

A method of making a touch fastener includes continuously introducing molten resin to a pressure zone at a peripheral surface of a rotating mold roll, such that pressure in the pressure zone forces some of the resin into an array of stem cavities defined in the mold roll to form resin stems while a remainder of the resin forms a base at the roll surface, interconnecting the stems. The method includes forming engageable heads on the stems to form fastener elements and introducing a quantity of discrete, loose fibers to the resin. The fibers pass through the pressure zone with the resin and become individually and separately bonded to the resin to become part of the base.

### TECHNICAL FIELD

This disclosure relates to touch fasteners with embedded fibers.

### BACKGROUND

In general, touch fasteners include two mating components that engage and substantially retain each other. Hook and loop fasteners include: a hook component having upstanding, hook type fastener elements; and a loop component having a surface of fibers or fiber loops capable of retaining the hook type fastener elements. Some hook type fastener elements have mushroom-like heads, while some are shaped like hooks defining crooks and extending in a particular direction. Hook-engageable loop components generally include knitted, woven, and non-woven textiles. A common example of a non-woven textile is a “spun bonded” textile made by spinning fine filaments of plastic resin (e.g. polypropylene) and distributing them in superimposed layers. The fibers are bonded to each other in random orientations with a fine, low-lying, nappy layer of looped and arched fibers exposed at the surface of the fabric.

### SUMMARY

In one aspect, a method of making a touch fastener includes continuously introducing molten resin to a pressure zone at a peripheral surface of a rotating mold roll, such that pressure in the pressure zone forces some of the resin into an array of stem cavities defined in the mold roll to form resin stems while a remainder of the resin forms a base at the roll surface, interconnecting the stems. The method includes forming engageable heads on the stems to form fastener elements and introducing a quantity of discrete, loose fibers to the resin. The fibers pass through the pressure zone with the resin and become individually and separately bonded to the resin to become part of the base.

In some implementations, the pressure zone (e.g. a nip) is formed between the peripheral surface of the rotating mold roll and a peripheral surface of a rotating pressure roll. In other implementations, the pressure zone is formed between the peripheral surface of the rotating mold roll and a peripheral surface of the extruder. The fibers are generally introduced at an entrance to the pressure zone. The method may further include continuously introducing a flexible substrate to the pressure zone, where the base of resin is laminated to the substrate on the peripheral surface of the pressure roll, such that the substrate becomes permanently bonded to the base. The fibers may be continuously deposited onto the flexible substrate, which carries the fibers into the pressure zone, thereby exposing the fibers to the molten resin during formation of the base, and securing individual fibers to the resin. The method may include orienting the fibers for deposition of a pattern of fibers. In some instances, the loose fibers are introduced to the pressure zone as a continuous stream.

By selectively choosing the fibers and introducing them to the molten resin, the resulting formed base may advantageously achieve a coefficient of friction (MIU) of between about 0.125 and about 0.4, a frictional roughness (MMD) of between about 0.01 and about 0.2, and a geometrical roughness (SMD) of between about 1.5 μm and about 7.0 μm. In one preferred implementation, the base preferably appears cloth-like and feels cloth-like by having a coefficient of friction (MIU) of between about 0.145 and about 0.16, a frictional roughness (MMD) of between about 0.009 and about 0.015, and a geometrical roughness (SMD) of between about 4.3 μm and about 6.7 μm. In another preferred implementation, the base preferably appears cloth-like, but does not necessarily feel cloth-like by having a coefficient of friction (MIU) of between about 0.1 and about 0.25, a frictional roughness (MMD) of between about 0.003 and about 0.02, and a geometrical roughness (SMD) of between about 1.5 μm and about 4.0 μm. Instead, this base may feel relatively smooth (e.g. as with plastic tape). The base may be opaque and the fibers may include a non-woven material, cotton, polyester, and rayon.

In some implementations, the method includes continuously introducing a carrier sheet to the pressure zone along the peripheral surface of a rotating pressure roll. The fibers are deposited onto the carrier sheet, which carries the fibers into the pressure zone, thereby exposing the fibers to the molten resin during formation of the base, and securing individual fibers to the resin. The carrier sheet is then removed the from the molded base.

The method may include depositing the fibers onto the peripheral surface of a nip carrier roll comprising at least one of the mold roll and a pressure roll, the nip carrier roll carrying the fibers into the pressure zone to join the molten resin and secure individual fibers to the resin. In some examples, the nip carrier roll defines pillow cavities carrying a pillow of deposited loose fibers into the nip. The pillow of loose fibers substantially secures to the resin. The nip carrier roll may retain the deposited fibers on the peripheral surface of the roll by electro-static adhesion, a liquid, and/or a tacky substance until the deposited fibers engage the liquid resin. In some instances, the peripheral surface of the nip carrier roll defines undulations configured to hold fibers. The method may also include applying a vacuum to the peripheral surface of the nip carrier roll to carry the fibers. The nip carrier roll may selectively carry the deposited fibers on fiber retention regions defined by the roll that are surrounded by fiber-free regions of the peripheral surface of the nip carrier roll. The fiber retention region defines a pattern on the roll, in some instances, that is imparted to the liquid resin.

In another aspect, a method of making a touch fastener includes introducing molten resin to a nip formed between a peripheral surface of a rotating mold roll and a peripheral surface of a rotating pressure roll, such that the resin at least partially fills an array of cavities defined in the rotating mold roll to form resin stems while a base of resin is formed interconnecting the stems. The method includes forming engageable heads on the stems and continuously applying a batt of fibers to at least one of the mold roll and the pressure roll, thereby exposing the batt of fibers to the molten resin during formation of the base and securing individual fibers of the batt to the resin. The method also includes substantially removing excess fibers from the base. The resulting base may advantageously achieve a coefficient of friction (MIU) of between about 0.125 and about 0.4, a frictional roughness (MMD) of between about 0.01 and about 0.2, and/or a geometrical roughness (SMD) of between about 1.5 μm and about 7.0 μm. In some implementations, after continuously applying a batt of fibers, the method includes substantially orienting (e.g. combing) the deposited fibers on the roll.

In yet another aspect, a touch fastener includes an elongated resin base having upper and lower surfaces and a plurality of touch fastener elements extending from the upper surface. Individuals fibers are secured to a surface of the base and provide a base surface roughness of between about 1.5 μm and about 7.0 μm, a coefficient of friction of between about 0.125 and about 0.4, and a frictional roughness of between about 0.01 and about 0.2.

The details of one or more implementations of the disclosure are set fourth in the accompanying drawings and the description below. Other features, objects, and advantages will be apparent from the description and drawings, and from the claims.

### DESCRIPTION OF DRAWINGS

FIGS. 1-2 are schematic views of manufacturing processes forming touch fasteners including depositing fibers onto molten resin upstream of a forming nip.

FIGS. 3-4 are schematic views of manufacturing processes for forming touch fasteners including depositing fibers onto at least one of a moll roll and a pressure roll.

FIG. 5 is a schematic view of a manufacturing process for forming touch fasteners including continuously introducing a substrate to a forming nip.

FIG. 6 is a schematic view of a manufacturing process for forming touch fasteners including continuously introducing a substrate to a forming nip and depositing fibers onto the substrate.

FIG. 7 is a schematic view of a manufacturing process for forming touch fasteners including depositing fibers onto a carrier sheet, which carries the fibers into a forming nip.

FIG. 8 is a schematic view of a manufacturing process for forming touch fasteners including continuously introducing a batt of fibers to a forming nip.

FIG. 9 is a schematic view of a pressure roll defining fiber carrying cavities, as a portion of a manufacturing process for forming touch fasteners.

FIG. 10 is a schematic view of a pressure roll defining fiber retention regions, as a portion of a manufacturing process for forming touch fasteners.

FIG. 11 is a schematic view of a manufacturing process for forming touch fasteners including depositing fibers onto molten resin upstream of a forming nip.

FIG. 12 is a side view, in partial cross-section, illustrating molten plastic extrusion into a forming nip between first and second coacting forming rollers.

FIG. 13 is a side view of a touch fastener with an array of fastener elements and embedded fibers on a bottom base surface.

FIG. 14 is a top view of the touch fastener of FIG. 13.

FIG. 15 is a side view of a touch fastener with embedded fibers on a bottom base surface.

FIG. 16 is a side view of a touch fastener with embedded fibers on top and bottom base surfaces.

FIG. 17 is a top perspective view of a touch fastener with embedded fibers visible on a base of the touch fastener.

FIG. 18 is a bottom perspective view of a touch fastener with embedded fibers visible on a base of the touch fastener.

Like reference symbols in the various drawings indicate like elements.

### DETAILED DESCRIPTION

Touch fastener components are used for personal care, industrial, consumer, and automotive applications, inter alia. In certain applications, the look and/or feel of the touch fastener component is an important factor. For example, in personal care applications (e.g. diapers), a touch fastener component having the look and feel of cloth or fabric is generally desirable. The comfort sensation of a fabric has many attributes and is generally described by a “fabric hand or handle”. Fabric hand is related to properties including flexibility, compressibility, elasticity, resilience, density, surface contour (e.g. roughness, smoothness), surface friction and thermal character. The drape of a fabric is an important aspect of fabric aesthetics and relates to the shape of the fabric while hanging down from its own weight.

Fabric hand attributes can be determined subjectively (e.g., based on a person's experience and touch sensitivity) and objectively. One objective method of determining fabric hand attributes is the Kawabata Evaluation System for fabrics (KES-F). Characteristic values in the KES-F system include tensile, sheering, bending, compression, surface, weight, and thickness properties, each measured in both the warp and weft directions. An average value for each property may be obtained by averaging the measurements in the warp and weft directions. The surface properties include a coefficient of friction (MIU), frictional roughness (MMD), which is the mean deviation of MIU, and a geometrical or surface roughness (SMD). The coefficient of friction (MIU) and frictional roughness (MMD) values are 0 to 1 values, where a higher value corresponds to greater friction or roughness. Roughness is a measurement of the small-scale variations in the height of a physical surface, in contrast to large-scale variations, which may be part of the geometry of the surface. Geometrical roughness (SMD) is measured in microns, where a higher value corresponds to greater roughness.

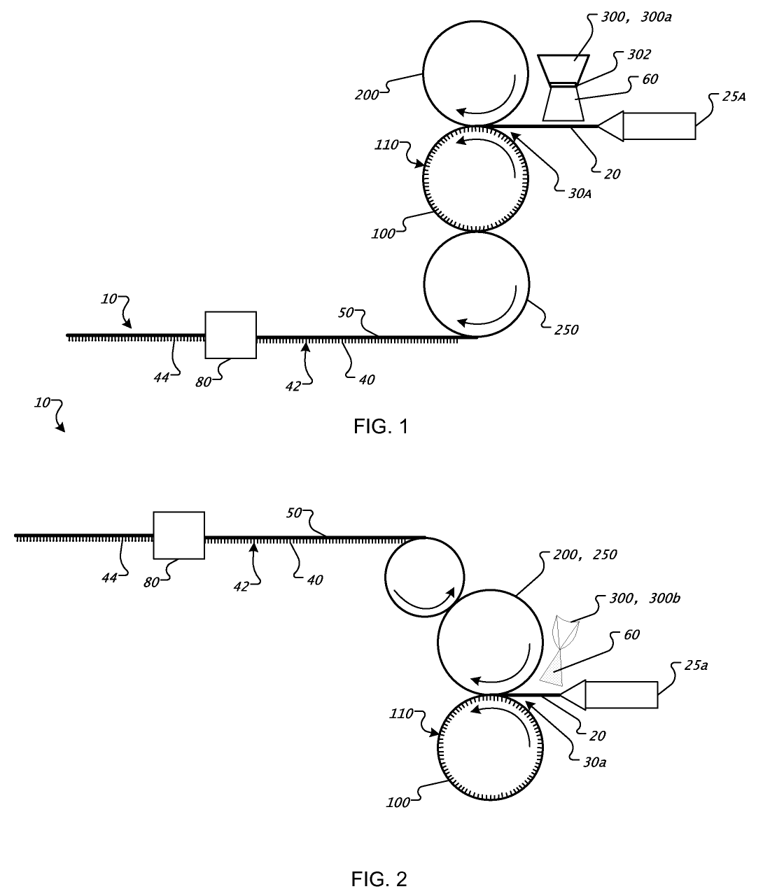

Referring to FIGS. 1-4, a method of making a touch fastener 10 includes continuously introducing molten resin 20 to a nip 30 formed adjacent a peripheral surface of a rotating mold roll 100. In some implementations, the method includes continuously introducing molten resin 20 (e.g. via an extruder 25a) to a nip 30a formed between a peripheral surface of a rotating mold roll 100 and a peripheral surface of a rotating pressure roll 200, as illustrated in FIGS. 1-3. In other implementations, the method includes continuously introducing molten resin 20 to the nip 30 from an extruder 25b to a nip 30b formed between a peripheral surface of a rotating mold roll 100 and a peripheral surface of the extruder 25b, as shown in FIG. 4. The process is similar to that described above, except only a mold roll 100 is used, i.e., no pressure roll 200 is necessary. Here, the extruder 25b is shaped to conform to the periphery of the mold roll 100 and the extruded resin 20 is introduced under pressure directly to the nip 30b formed between mold roll 100 and extruder 25b. The resin 20 at least partially fills an array of cavities 110 defined in the rotating mold roll 100 to form resin stems 40 while a base 50 of resin 20 is formed interconnecting the stems 40. The molded fastener component 10 is stripped from the mold cavities 110 by a release roll 250. Further details regarding this process are described in U.S. Pat. Nos. 4,794,028, 5,781,969, and 5,913,482, the entire contents of which are hereby incorporated by reference.

Referring to FIGS. 1-2, in some implementations, the method includes adding loose fibers 60 (e.g., substantially separate, unattached, free floating fibers) to the molten resin 20 upstream of the nip 30. The fibers 60 may be held in a hopper or bin 300 from which they are released and deposited onto the molten resin 20. In some examples, the fibers 60 are released from the hopper 300a in random orientations or though a screen or aligner 302, which orients the fibers 60 in a particular pattern for deposition onto the molten resin 20. In other examples, the fibers 60 are blown onto the molten resin 20 with a fiber blower 300b, providing fiber deposition in random fiber orientations. Heat and pressure in the nip 30 secure individual fibers 60 to the resin base 50. In some examples, the fibers 60 are made of a non-woven material. The fibers 60 may also include cotton or wood fiber, polyester, polyethylene, polypropylene, terephthalate, rayon, and/or blended fibers or multi-component fibers.

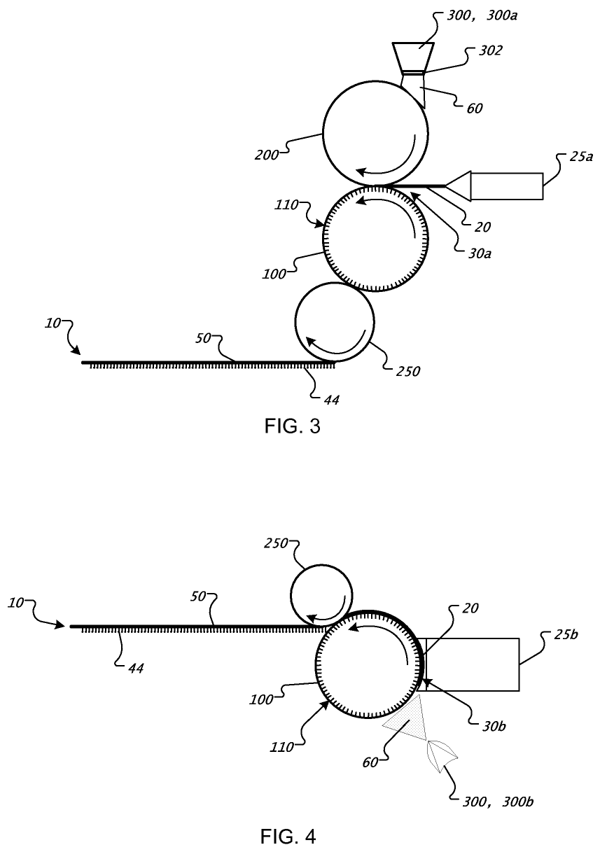

Referring to FIGS. 3-4, in some implementations, the method includes continuously depositing loose fibers 60 onto at least one of the mold roll 100 and the pressure roll 200, the roll 100, 200 carrying the fibers 60 into the nip 30. In some examples, the loose fibers 60 are released from the hopper 300a in random orientations or though a screen or aligner 302, which orients the fibers 60 in a particular pattern for deposition onto the roll 100, 200. In other examples, the fibers 60 are blown onto the roll 100, 200 with a fiber blower 300b, providing fiber deposition in random fiber orientations. The fibers 60 are exposed to the molten resin 20 during formation of the base 50. Heat and pressure in the nip 30 secure individual fibers 60 to resin base 50.

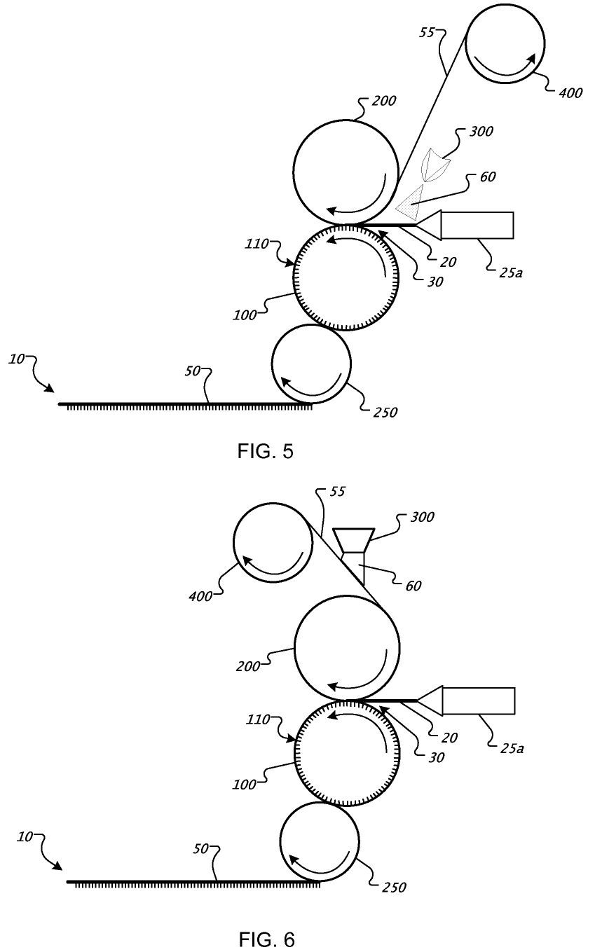

Referring to FIGS. 5-6, in some examples, the method further includes continuously introducing a flexible substrate 55 from a substrate roll 400 to the nip 30 such that the resin base 50 is laminated to the substrate 55 on the peripheral surface of the pressure roll 200. Heat and pressure in the nip 30 (also referred to as a gap) laminate and bond the substrate 55 to the thermoplastic resin 20 while simultaneously forming the fastener stems 40. The result can be a contiguous molded structure, without seams or weld lines, extending from the tips 42 of the fastener 10 into the substrate 55, where the resin can intimately bond with features or fibers of the substrate 55 to form a strong, permanent bond. Further details regarding this process are described by Kennedy et al., U.S. Pat. No. 5,260,015, the disclosure of which is hereby incorporated in its entirety by reference. In some implementations, the fibers 60 are continuously deposited onto the substrate 55 which carries the fibers 60 into the nip 30, as shown in FIG. 6, exposing the fibers 60 to the molten resin 20 during formation of the base 50. The substrate 55 may have a tacky or retentive quality that retains the fibers 60 on the surface of the substrate 55. Heat and pressure in the nip 30 secure individual fibers 60 to the resin base 50. The resin 20 and/or the substrate 55 may be substantially transparent to accentuate a visual appearance of the embedded fibers 60.

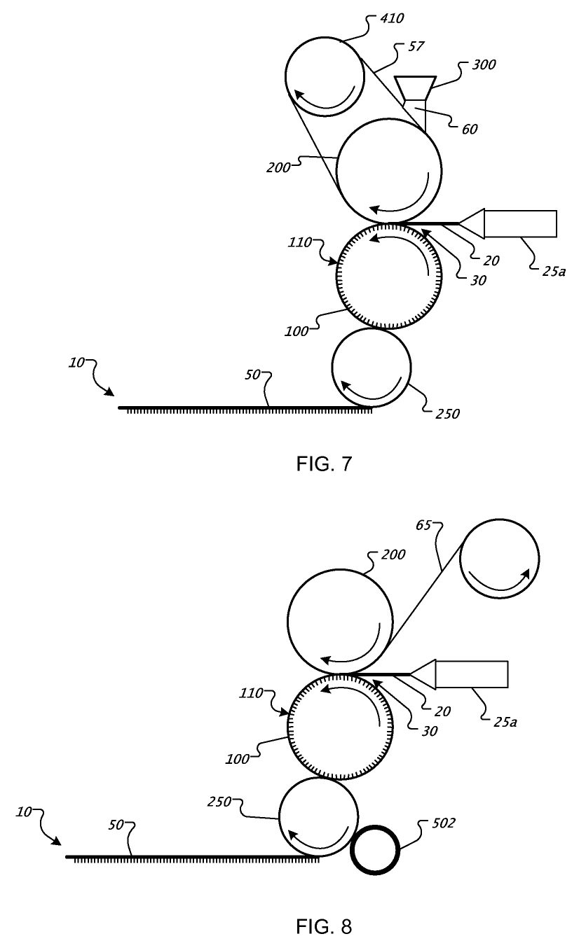

In the example illustrated in FIG. 7, loose fibers 60 are continuously deposited onto a carrier sheet 57 which carries the fibers 60 into the nip 30, exposing the fibers 60 to the molten resin 20 during formation of the base 50. The loose fibers 60 may be deposited in a random or oriented manner. The carrier sheet 57 has a tacky or retentive quality that retains the fibers 60 on the surface of the carrier sheet 57. In some examples, the carrier sheet 57 defines undulations or surface features that provide corresponding surface features on the molded base 50. Heat and pressure in the nip 30 secure individual fibers 60 to the resin base 50. The carrier sheet 57 is stripped from the molded base 50 after formation of the fastener component 10. In some examples, the carrier sheet 57 is a continuous sheet trained about the pressure roll 200 and a carrier sheet/tape roll 410.

In the example illustrated in FIG. 8, the method includes continuously applying a batt of fibers 65 to at least one of the mold roll 100 and the pressure roll 200, the roll 100, 200 carrying the batt 65 of fibers 60 into the nip 30. In one example, the batt 65 of fibers 60 is a sheet of cotton. The batt 65 of fibers 60 is exposed to the molten resin 20 during formation of the base 50. Heat and pressure in the nip 30 secure individual fibers 60 from the batt 65 of fibers 60 to the resin base 50. Remaining excess fibers 60 from the batt 65 of fibers 60 are removed from the roll 100, 200 and the base 50 and can be subsequently reused.

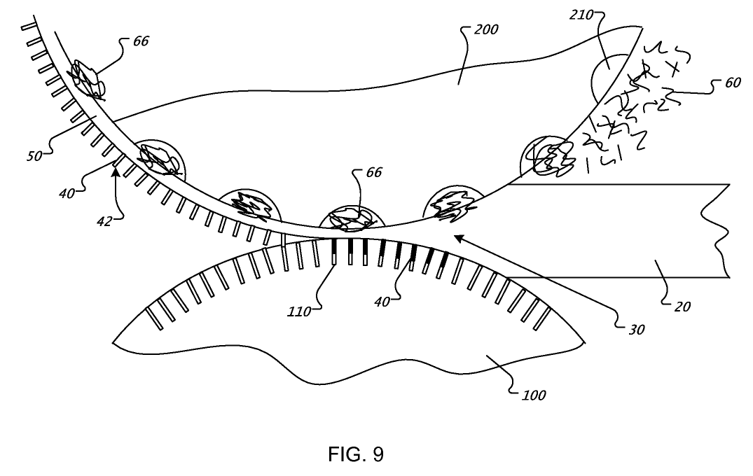

As illustrated in FIG. 9, the roll 100, 200 defines pillow cavities 210 that carry a pillow 66 of deposited loose fibers 60 into the nip 30, such that the pillow 66 of loose fibers 60 is substantially secured to the resin 20. In the example shown, the pressure roll 200 defines pillow cavities 210 that carry pillows 66 of loose fibers 60 deposited on the roll 200 into the nip 30.

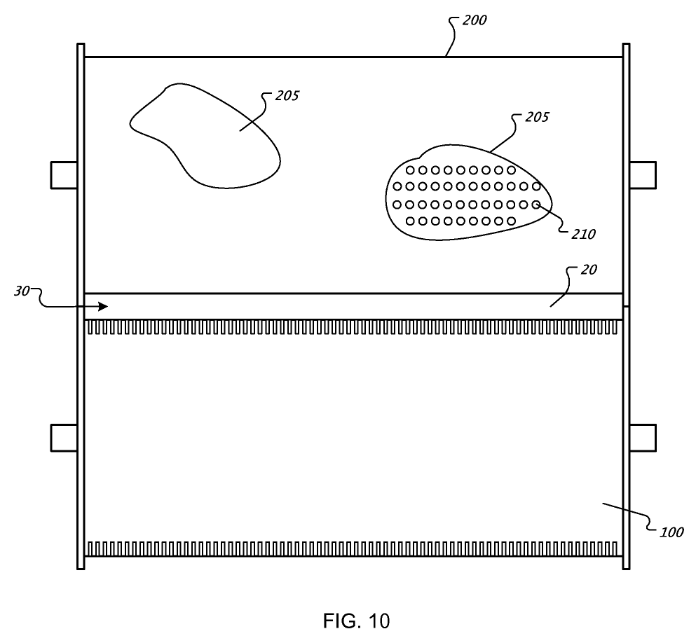

Referring to FIG. 10, in some implementations, the deposited loose fibers 60 are retained on discrete fiber retention regions 205 of the peripheral surface of the mold roll 100 and/or pressure roll 200. The retention regions 205 may be configured to define a pattern (e.g. plaid, checked, figures, etc.). In some instances, the deposited loose fibers 60 are retained on the peripheral surface of the mold roll 100 or pressure roll 200 by other retention means, such as electro-static adhesion, surface tension, a tacky substance, or vacuum pressure, for example. In the example of electro-static adhesion, a static charge is applied to the roll 100, 200 which then attracts and retains deposited fibers 60 on the peripheral surface of the roll 100, 200. When a liquid is applied to the roll 100, 200, surface tension of the liquid retains deposited fibers 60 on the peripheral surface of the roll 100, 200. In the example of vacuum pressure, the roll 100, 200 defines vacuum paths 210 through or along its peripheral surface that are configured to retain deposited fibers 60 on the peripheral surface of the roll 100, 200. The vacuum paths 210 are disposed in one or more of the fiber retention regions 205. In some examples, the peripheral surface of the mold roll 100 and/or pressure roll 200 defines undulations 210 configured to carry the deposited loose fibers 60. The undulations 210 may also be used to provide different surface characteristics of the base 50 (e.g. modified surface roughness, waviness, textured surface, embossing, etc).

The method includes forming stems 40 on a base 50 of resin 20. The resin 20 at least partially fills the array of cavities 110 defined in the rotating mold roll 100 to form resin stems 40 while a base 50 of resin 20 is formed interconnecting the stems 40. The forming roller 100 and the pressure roller 200 are configured to permit relief of pressure at the laterally opposite sides of their interface so that the lateral flow of plastic material at the interface is unconfined. This arrangement has been found to provide added flexibility in practicing the present method since sufficient molten plastic material can be provided in the form of extrusion 20 to assure complete filling of the hook-forming cavities 110, while at the same time excessive pressure is not created at the interface which could otherwise act to urge the rollers 100 and 200 away from each other. As will be appreciated, appropriate selection of the linear forming speeds of the fastener member 10, as well as appropriate temperature control can avoid the need for providing pressure relief at the roller interface. In this regard, it will be observed in FIG. 12 that an enlarged “bank” designated 21 is formed just upstream of the interface of the forming roller 100 and the pressure roller 200. While it is desired that the bank 21 be of minimum dimension to avoid urging the rollers 100 and 200 apart, the creation of this bank assures the presence of an adequate supply of molten plastic material for complete filling of the hook-forming cavities 110. Fibers 60 applied to one of the forming rolls 100, 200 meet the bank 21 of resin 20 as the particles 60 are carried into the nip 30, where the fibers 60 become integral with the formed base 50. Once transferred to the resin 20, the fibers 60 are unrestrained in movement and flow. Consequently, the fibers 60 may mix with resin 20 and move in one or more directions (e.g., longitudinal and/or transverse directions with respect to a feed direction).

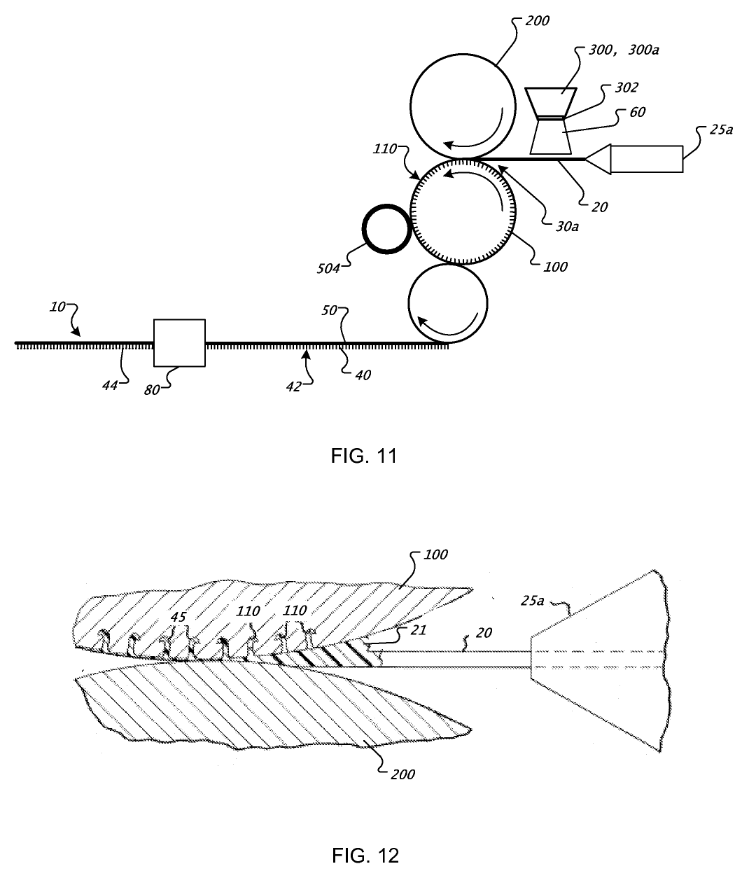

In the examples illustrated in FIGS. 8 and 11, the method includes substantially removing excess fibers 60 from the base 50. In one illustrated example, a brush 502 engages the back surface of base 50 to remove excess fibers 60. The brush may be rotating against the motion of the stripper roll 250, or stationary. In another example, a tacky roller 504 applied to the base 50 removes excess fibers 60. Other examples of removing excess fibers 60 from the base 50 include applying and removing a tacky sheet, blowing air, washing, abrading or scraping the base 50. In some implementations, the method includes substantially orienting the deposited fibers 60, such as by combing the fibers upstream of the nip 30, and in some cases after they are deposited on a substrate 55, carrier sheet 57, or roll 100, 200.

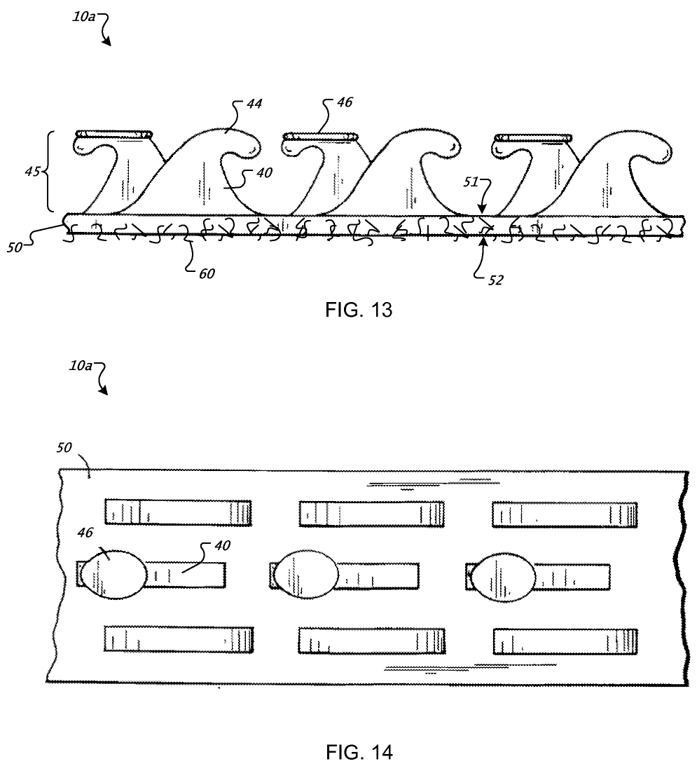

Referring again to FIGS. 1-2, the method includes forming engageable heads 44 on the stem tips 42 with a tip forming device 80. In some examples, the tip forming device 80 includes a roller that flattens the stem tips 42 into engageable heads 44. Referring again to FIGS. 3-4 and 12, in other examples, the entire fastener elements 45, including engageable heads 44 on the tips 42 of stems 40, are formed while in the nip 30. The cavities 110 defined by the mold roll 100 are shaped to form stems 40 with engageable heads 44 on the tips 42 of stems 40. Each hook projection 45 is provided with a configuration wherein the free end portion 42 of each projection 45 extends generally radially away from and generally toward the base portion 50 of the fastener 10. It should further be noted that adjacent hook projections 45 face in generally opposite directions in a direction along the length of the fastener 10. These features of the construction promote the desired interaction with the associated multi-loop fastener element, and assure the desired gripping or fastening action between the multi-hook fastener member and the multi-loop element. The engageable heads 44 flex or rotate about the stem during release from the mold roll 100. In the example illustrated in FIGS. 13-14, engageable heads 44 of the touch fastener 10 are deformed (e.g. flattened) by a tip forming device 80 to form flat portion 46 on the engageable head 44.

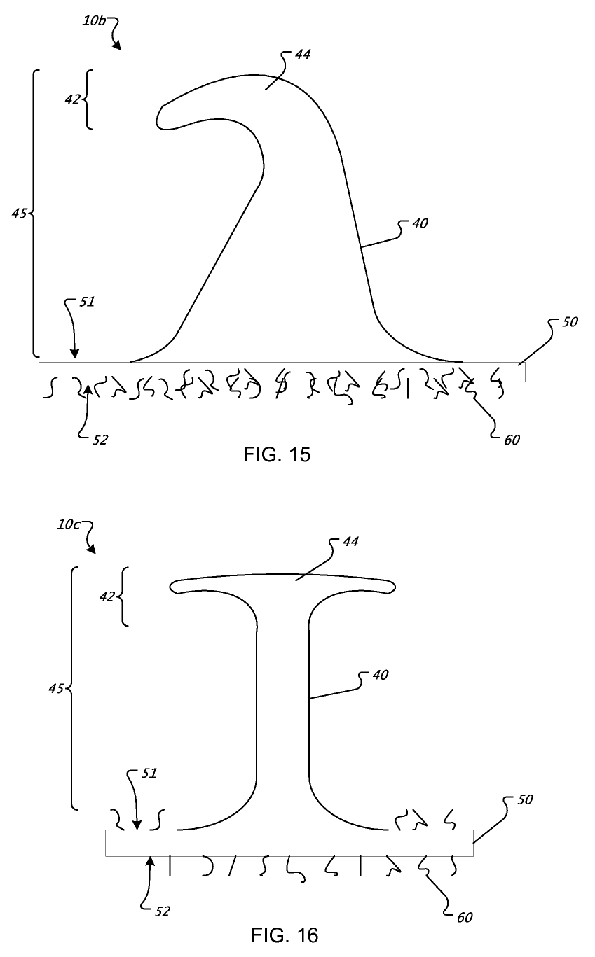

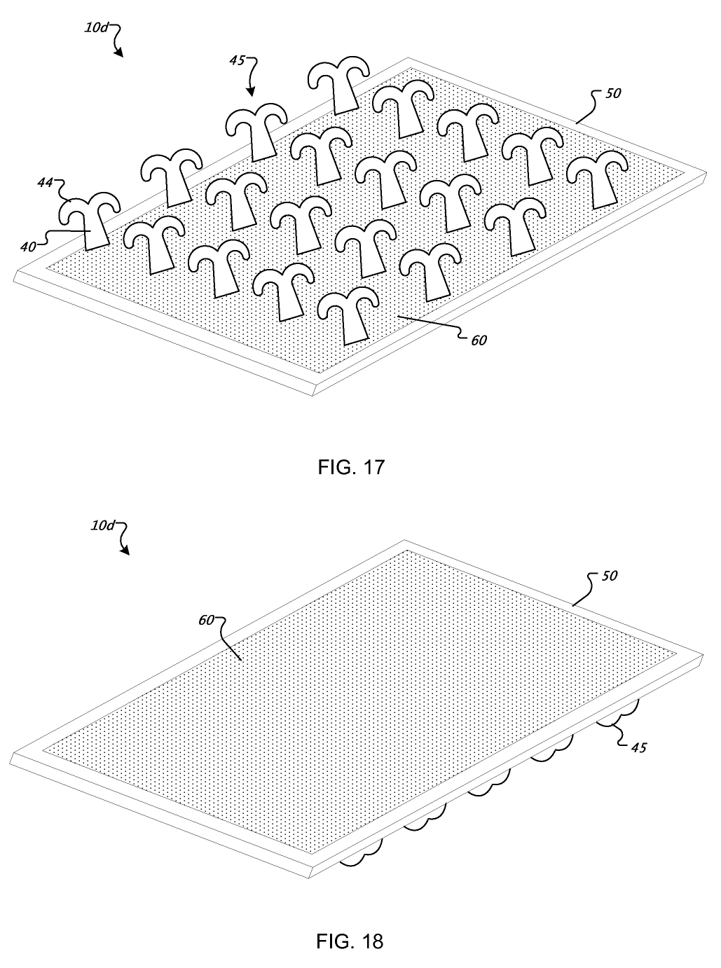

Referring to FIGS. 13-18, a touch fastener 10a, 10b, 10c, 10d (e.g. as resulting from the methods of manufacture described herein) includes an elongated resin base 50 having upper and lower surfaces 51 and 52, respectively, and a plurality or array of touch fastener elements 45 extending from the upper surface 51. Individual fibers 60 are secured to a surface 51, 52 of the base 50, advantageously providing a coefficient of friction (MIU) of between about 0.125 and about 0.4, a frictional roughness (MMD) of between about 0.01 and about 0.2, and a geometrical roughness (SMD) of between about 1.5 μm and about 7.0 μm. The aforementioned ranges of surface properties for the base 50 objectively characterize hand with various degrees of cloth-like appearance and feel. In one preferred implementation, the resulting base 50 appears cloth-like, feels cloth-like, and has a coefficient of friction (MIU) of between about 0.145 and about 0.16, a frictional roughness (MMD) of between about 0.009 and about 0.015, and a geometrical roughness (SMD) of between about 4.3 μm and about 6.7 μm. In another preferred implementation, the resulting base 50 appears cloth-like, but does not necessity feel cloth-like, and has a coefficient of friction (MIU) of between about 0.1 and about 0.25, a frictional roughness (MMD) of between about 0.003 and about 0.02, and a geometrical roughness (SMD) of between about 1.5 μm and about 4.0 μm. This base 50 may feel relatively smooth (e.g. as with plastic tape). Providing a resin fastener 10 with a fabric hand substantial similar to cloth is advantageous to personal care implementations, inter alia.

A number of implementations have been described. Nevertheless, it will be understood that various modifications may be made without departing from the spirit and scope of the disclosure. Accordingly, other implementations are within the scope of the following claims.

What is claimed is:

1. A method of making a touch fastener, the method comprising:
continuously introducing molten resin to a pressure zone at a peripheral surface of a rotating mold roll, such that pressure in the pressure zone forces some of the resin into an array of stem cavities defined in the mold roll to form resin stems while a remainder of the resin forms a base at the roll surface, interconnecting the stems;
forming engageable heads on the stems to form fastener elements; and
introducing a quantity of discrete, loose fibers to the resin, such that the fibers pass through the pressure zone with the resin and become individually and separately bonded to the resin to become part of the base.

2. The method of claim 1, wherein the pressure zone is formed between the peripheral surface of the rotating mold roll and a peripheral surface of a rotating pressure roll.

3. The method of claim 2 further comprising continuously introducing a flexible substrate to the pressure zone, wherein the base of resin is laminated to the substrate on the peripheral surface of the pressure roll such that the substrate becomes permanently bonded to the base.

4. The method of claim 3 wherein the fibers are introduced to the resin while being carried into the pressure zone on the flexible substrate.

5. The method of claim 1, wherein the pressure zone is formed between the peripheral surface of the rotating mold roll and a peripheral surface of an extruder.

6. The method of claim 1, wherein the fibers are introduced at an entrance to the pressure zone.

7. The method of claim 1, wherein the formed base has a surface roughness of between about 1.5 μm and about 7.0 μm

8. The method of claim 1, wherein the formed base has a coefficient of friction of between about 0.125 and about 0.4.

9. The method of claim 1, wherein the formed base has a frictional roughness of between about 0.01 and about 0.2.

10. The method of claim 1 further comprising orienting the fibers for deposition of a pattern of fibers.

11. The method of claim 1, wherein the base is opaque.

12. The method of claim 1, wherein the fibers are introduced to the pressure zone as a continuous stream of loose fibers.

13. The method of claim 1, wherein the fibers comprise cotton.

14. The method of claim 1 further comprising:
introducing a continuous carrier sheet to the pressure zone along the peripheral surface of a rotating pressure roll; and
depositing the fibers onto the carrier sheet, the carrier sheet carrying the fibers into the pressure zone.

15. The method of claim 1 further comprising continuously depositing the fibers onto the peripheral surface of a nip carrier roll that carries the fibers into the pressure zone to join the molten resin and secure individual fibers to the resin.

16. The method of claim 15, wherein the nip carrier roll defines pillow cavities that each carry a pillow of deposited fibers into the pressure zone, the pillow of fibers substantially securing to the resin.

17. The method of claim 15, comprising retaining the deposited fibers on the nip carrier roll by electro-static adhesion.

18. The method of claim 15, comprising applying a liquid to the roll onto the nip carrier roll, the liquid retaining the deposited fibers until the deposited fibers engage the liquid resin.

19. The method of claim 15, comprising applying a tacky substance to the nip carrier roll, the tacky substance retaining the deposited fibers until the deposited fibers engage the liquid resin.

20. The method of claim 15, wherein the peripheral surface of the nip carrier roll defines undulations capable of retaining fibers.

21. The method of claim 15 further comprising applying a vacuum to the peripheral surface of the nip carrier roll to retain the particles thereon.

22. The method of claim 15, wherein the nip carrier roll selectively carries the deposited fibers on at least one fiber retention region surrounded by fiber-free regions of the peripheral surface of the nip carrier roll.

23. The method of claim 22, wherein the fiber retention region defines a pattern on the roll that is formed on a surface of the base.

24. A touch fastener comprising:
an elongated resin base having upper and lower surfaces and a plurality of touch fastener elements extending from the upper surface; and
individuals fibers secured to a surface of the base and providing a base surface roughness of between about 1.5 μm and about 7.0 μm, a coefficient of friction of between about 0.125 and about 0.4, and a frictional roughness of between about 0.01 and about 0.2.
